(19) United States
(12) Patent Application Publication
(10) Pub. No.: US 2009/0061897 A1
(43) Pub. Date: Mar. 5, 2009

(54) TRACKING, SECURITY AND MONITORING SYSTEM FOR CARGOS

(75) Inventors: Patrick Hamilton, Calgary (CA); Michael Barker, Calgary (CA); Wilfred Mueller, Calgary (CA); Francisco Litorco, Calgary (CA); Allan L.A. Scribner, Calgary (CA)

Correspondence Address: DAVIDSON BERQUIST JACKSON & GOWDEY LLP, 4300 WILSON BLVD., 7TH FLOOR, ARLINGTON, VA, 22203, US

(73) Assignee: DataTrail Inc., Calgary (CA)

(21) Appl. No.: 12/138,087

(22) Filed: Jun. 12, 2008

Related U.S. Application Data
(60) Provisional application No. 60/943,349, filed on Jun. 12, 2007.

(51) Int. Cl. H04W 24/00; G05B 19/00

(52) U.S. Cl. 455/456.2; 340/5.1; 340/825.49; 342/357.1

(57) ABSTRACT

The invention describes a tracking, security and status monitoring system (TSS) and modular tracking and security device (MTSD). The tracking and security system includes at least one MTSD adapted for containment within a shipment within a vehicle and for operative communication with a global navigation satellite system (GNSS) (such as the global positioning system (GPS)), cellular networks and a monitoring system. In various embodiments, the MTSD is modular allowing for different sensor systems to be configured to the system, is operative to optimize power consumption and network data usage in the absence of a security event or inquiry from the monitoring system and/or allows the MTSD to recognize when it is within an airborne aircraft to comply with aviation regulations with respect to the operation of RF devices within aircraft. In addition, the system, by using both GNSS and cellular technology (ie. assisted GPS) is effective in being able to determine the real time position of a shipment from a greater number of positions and from deeper within shipment containers or vehicles.

### RELATED APPLICATIONS

This application is related to and claims the benefit under 35 U.S.C. §119(e) of U.S. provisional application No. 60/943,349, filed Jun. 12, 2007 and titled “Tracking and Security System”, the entire contents of which are fully incorporated herein for all purposes.

### FIELD OF THE INVENTION

The invention describes a tracking, security and status monitoring system (TSS) and modular tracking and security device (MTSD). The tracking and security system includes at least one MTSD adapted for containment within a shipment within a vehicle and for operative communication with a global navigation satellite system (GNSS) (such as the global positioning system (GPS)), cellular networks and a monitoring system. In various embodiments, the MTSD is modular allowing for different sensor systems to be configured to the system, is operative to optimize power consumption and network data usage in the absence of a security event or inquiry from the monitoring system and/or allows the MTSD to recognize when it is within an airborne aircraft to comply with aviation regulations with respect to the operation of RF devices within aircraft. In addition, the system, by using both GNSS and cellular technology (ie. assisted GPS) is effective in being able to determine the real time position of a shipment from a greater number of positions and from deeper within shipment containers or vehicles.

### BACKGROUND OF THE INVENTION

The shipment of cargo is a well-established, multi-billion dollar industry where all nature of goods are transported using almost any type of vehicle including bicycles, automobiles, vans, trucks and trailers, trains, planes, ships etc.

Cargo shipments are generally categorized as local or non-local. Local shipments will generally involve fewer handling steps and will likely utilize only large and small automobiles or trucks. Non-local shipments will generally involve a greater number of handling and transferring steps wherein the cargos will pass through one or more distribution or handling centers. Non-local shipments will often utilize a wider variety of shipment vehicles such as tractor trailers, trains, planes and ships. An example of a typical local shipping cycle of a cargo may be:
a. the cargo is picked-up from the sender (consignor) and placed in a van or small truck; and,
b. the cargo is transported to a sorting facility where it is routed to other vehicles for local delivery to a receiver (consignee).
   An example of a non-local shipping cycle may be:
a. the cargo is picked-up from the sender and placed in a van or small truck;
b. the cargo is transported to a sorting facility;
c. the cargo is transferred to an aircraft for transport to a centralized sorting/routing facility;
d. the cargo is sorted at the centralized sorting/routing facility;
e. the cargo is transferred to a second aircraft for transport to a regional or local sorting/routing facility; and,
f. the cargo is transferred to a vehicle for local delivery.

For many shipping customers, due to the value or nature of the cargo, it is advantageous and important to the customer that the precise location of the cargo and its status is known during shipping for a number of reasons including security, insurance, and investigative/auditing reasons.

Recently, in view of the development of tracking technologies, it has become technically and economically possible to monitor and report the location of cargos moving or being transported throughout the delivery chain from the sender to the recipient such that various forms of “real-time” monitoring of the location of the package are possible.

The technologies that enable such monitoring include Global navigation Satellite Systems (GNSS), such as the Global Positioning System (GPS), as well as wireless data communications systems, such as the cellular networks. These technologies acting individually can provide highly effective tracking for many shipments and cargoes. However, each of these technologies, when acting independently, are limited in that neither technology can provide position tracking of a shipment in a broad range of situations. For example, GNSS is limited by the surrounding packaging and containers because a GNSS signal will not be received through the thickness of normal containers. Cellular technologies, while having greater penetration, are limited by the availability of the cellular networks.

Recently, improvements in these basic capabilities through the introduction of such advanced techniques as aided-GPS or assisted-GPS have improved the overall effectiveness of tracking by overcoming certain problems including tracking of cargo inside sealed compartments, such as the compartments of truck trailers, rail cars or aircraft. These improved technologies can evaluate the relative signal strength from either a GPS type signal or cellular signal and determine position by either system or a combination of either system.

In addition, such technologies enable the security systems that have been used within a vehicle to respond to an inquiry from a monitoring system and report the location of the vehicle back to the monitoring system. In various past systems, the security systems will regularly report back to the monitoring system to provide a position report to the monitoring system. However, past systems have generally been limited to specific applications where, for example, specific data related to a particular function of interest is reported. For example, a trucking company may simply inquire, “Where is trailer X?” wherein the system will respond by reporting a specific location. Such systems do not enable a multitude of sensors to be configured to a security system so as to report on a broad range of customizable attributes concerning the status of the package or cargo.

As security events may be specific to a specific cargo, such that different cargos would require that different types of events be reported to a monitoring system, it is desirable that a security system is flexible to meet the specific security needs of a particular shipment. For example, for a perishable cargo, it may be desired to monitor security events such as threshold changes in temperature, moisture, vibration, atmosphere or time-delay events whereas for a non-perishable fine art cargo, it may be desired to monitor threshold events relating to package tampering, vibration, moisture, location and time-delay. For magnetically sensitive or radiation sensitive cargos, it may be desired to monitor magnetic and radiation thresholds.

Accordingly, there has been a need for security system that allows the security system to be adapted to a broader range of shipping situations whilst optimizing the performance of the system through appropriate management of resources including power and wireless network time as well as providing the user with the ability to readily adapt the system to incorporate a variety of sensor combinations to a base processor. Such a system would thus permit a shipper to readily configure the most appropriate combination of sensors to a specific package.

Further still, there has been a need for a system that enables greater deployment of a tracking technology that is independent of the shipping method and that enables “transparent” package tracking by a greater of interested parties. For example, there has been a need for a system that is able to adapt to the specific type of transportation method being utilized, be that a ship, truck, rail or shipping container or an aircraft container whilst providing useful data to an interested party. That is, it is desirable for those monitoring the location of the package that they can be advised of the location of the package or alternatively can be advised of the most up-to-date status data concerning the package. For example, if location cannot be provided because the package is known to have passed to a known trigger point that would have shut down the tracking system (ie because it is on an aircraft) or it is outside cellular range, this information can be provided.

More specifically, and in the particular case of cargos being carried by air, there has been a need for a system that can respond to particular regulations such as the requirement that RF devices be turned off during flight. While various technologies enable the tracking of packages traveling by aircraft, the operation of such security systems are in violation of current United States Department of Transportation Federal Aviation Authority (FAA) regulations that require that such devices are turned off whilst the aircraft is airborne.

More specifically, FAA regulations (Title 14 of the Code of Federal Regulations (14 CFR) part 91, section 91.21. Section 91.21) were established because of the potential for portable electronic devices (PED) to interfere with aircraft communications and navigation equipment. These regulations prohibit the operation of personal electronic devices (PEDs) aboard U.S.-registered civil aircraft, operated by the holder of an air carrier operating certificate, an operating certificate, or any other aircraft while operating under instrument flight rules (IFR). In addition, the United States Department of Transportation Federal Aviation Authority (FAA) Advisory Circular 91.21 provides guidelines requiring that portable electronic devices (PEDs) are not used during takeoff and landing, as well as inflight.

Further still, while there has been a need for a system that can intelligently determine that a security device is being transported in an aircraft, there has similarly been a need for a system that can intelligently determine between a truck container being subject to changes in air pressure (such as being carried over a high mountain pass) and an aircraft container such that the occurrence and reporting of false events is minimized.

In summary, it is desirable in the design and implementation of a security system, that the system and related security devices are:
sized as small as possible to be readily contained within almost any package types without attracting the attention of would-be thieves;
able to report location data from a greater number of locations and in a greater number of shipping situations;
immediately report the time, nature of the security event to a monitoring system, such that appropriate action may be taken to evaluate and act upon the security event should it occur;
adaptable to specific security needs to provide the greatest amount of flexibility to almost any shipper in order to provide a desired security functionality; and,
operational for long periods of time by being able to effectively reduce its power requirements and/or conserve power whilst also being able to respond to particular shipping situations where regulations may govern the operation of such devices.

A review of the prior art indicates that no previous tracking systems having considered or addressed the foregoing.

For example, US Patent Publication 2004/0194471 to Rickson discloses a container that maintains at least one environmental condition within the volume of the container within a predetermined range of values, a sensor for measuring environmental conditions within the container and a telecommunications device to transmit data relating to the environmental conditions via a telecommunications network to a monitoring system. However, Rickson does not teach an aided-GPS security system that is modular or independent of the shipping container or a security system having power saving and position enquiry features.

U.S. Pat. No. 6,281,797 to Forster et al. discloses a tracking device that is operatively contained with a shipping container including a Global Positioning System (GPS) for receiving positioning information and at least one sensor to monitor environmental conditions. The tracking device is able to receive sensor information and relay the information to a remote monitoring system or deactivate the tracking device when in close proximity or inside an aircraft. Forester does not disclose a modular design concept with which the components are added or removed or a system utilizing aided-GPS.

U.S. Pat. No. 6,342,836 to Zimmerman discloses a luggage location unit having a radio frequency transmitter intended to be carried inside a unit of luggage within the cargo hold of an aircraft including a flight profile detector in communication with the transmitter for inhibiting operation of said transmitter during at least part of the flight sequence. Zimmerman does not teach a device capable of using a Global Positioning System (GPS), Global Navigation Satellite System (GNSS) or aided-GPS to determine its geographic position and is unable to report its status to a remote monitoring system over a cellular telecommunications network.

U.S. Pat. No. 6,148,196 to Baumann discloses a remote control and location system comprising a remote unit, a mobile cell site for transmitting to and receiving data from the remote unit, a satellite for receiving and transmitting said data between a mobile cell site and master control facility and a master control facility for transmitting instructions to the remote until and for analyzing data returned by said remote unit. This technology is intended to be used in the training of soldier, monitoring of firefighters, police, prisoners etc. dispersed in large geographical areas.

U.S. Pat. No. 7,257,731 to Joao discloses an apparatus composed of a shipment conveyance device, a global positioning device, a processing device and a transmitter capable of reporting the geographical position of and environmental conditions within the shipping container to a remote monitoring system composed of any combination of computers belonging to the shipper, carrier, receiver or a central processing computer. The apparatus is able to respond to an enquiry of the shipment status. Joao does not teach a tracking device that is modular or that utilizes assisted-GPS.

### SUMMARY OF THE INVENTION

In a first embodiment, the invention provides a modular tracking security device (MTSD) for determining the position of a shipment and reporting the position and status of the shipment to a monitoring system, comprising:
a base module (BM) including:
   a BM central processing unit (CPU);
   a BM power supply;
   a BM interface enabling one or more sensors to be selectively configured to the BM CPU;
   at least one sensor operatively connected to the BM interface for detecting a security event with respect to the shipment;
   a BM local area network interface;
a communication module (CM) including
   a CM CPU;
   a CM power supply;
   a radio frequency (RF) positioning system including a global navigation satellite system (GNSS) receiver and a cellular network transceiver for determining the position of the MTSD based on data received from either or a combination of GNSS and cellular network data;
   a CM local area network interface;
wherein the BM and CM are operatively connected together by the BM local area network interface and the CM local area network interface and wherein the MTSD is operative to respond to a position enquiry from the monitoring system over the cellular network and to report position to the monitoring system in response to a position enquiry or a security event and wherein, in the absence of a position enquiry or security event, the MTSD is in a power save mode.

In one embodiment, the RF positioning system is an assisted-GPS system.

In various embodiments, the sensors that may be configured to the MTSD may be selected from any one of or a combination of light, pressure, acceleration, temperature, moisture, radiation, vibration, sound, magnetism, strain, switch, camera, radio frequency identification (RFID), electromagnetic, wireless local area network (WLAN), gas and tunable frequency sensors.

In a preferred embodiment, the MTSD includes an enclosure for containing the base module that enables the selective attachment of one or more sensor enclosure modules for configuring additional sensors to the base module to enable ready customization of the MTSD to the specific requirements of a customer and/or shipping package. In this case, the BM CPU is operative to recognize the attachment of various sensor combinations to the base module.

In another preferred embodiment, the base module includes an aircraft detection system to detect the MTSD's presence within an aircraft. In this embodiment, the BM CPU switches the MTSD to an aircraft mode when the MTSD is within the aircraft prior to take-off and the RF positioning system is turned off. In addition, the aircraft detection system detects that the MTSD has landed (after being airborne) in which case the MTSD CPU switches the RF positioning system to the power save mode.

The aircraft detection system can utilize a variety of sensor inputs to determine when the MTSD is in an aircraft prior to take-off, is airborne, has landed and/or has been removed from an aircraft.

In one embodiment, the aircraft detection system detects an increase in air pressure relative to ambient pressure to signal the MTSD's presence in the aircraft prior to take-off. Similarly, the system can detect a decrease in air pressure relative to ambient pressure to signal that the aircraft has landed.

In another and preferred embodiment, the aircraft detection system includes at least one accelerometer configured to the MTSD for detection of acceleration or vibration that in conjunction with a pressure sensing system signals the MTSD's presence in the aircraft prior to take off and the MTSD's presence in the aircraft after landing.

In another embodiment, the aircraft detection system monitors an increase in pressure such that if a pressure increase is detected in excess of a threshold grade for a given acceleration, speed or vibration as determined by an accelerometer, this causes the MTSD to report its location to the monitoring system, wherein the monitoring system accesses an airport proximity database to determine if the MTSD is within a pre-determined distance of an airport. If the MTSD is determined to be within a pre-determined distance of an airport, the RF communication system is turned off. If the RF communication system is turned off, the MTSD continues to monitor pressure to determine if the MTSD has become airborne. If the MTSD determines that the aircraft has not become airborne after a threshold period of time, the RF communication system is turned on and the MTSD reports its position to the monitoring system to confirm that the MTSD is not at or near an airport.

In another embodiment, aircraft landing is detected by monitoring pressure below a pressure threshold and correlating pressure data to acceleration, speed or vibration data.

In yet another embodiment, the MTSD's presence in an aircraft is determined by monitoring RF emission presence of 400 Hz and an absence of RF emission of 60 Hz, wherein the presence of a significant 400 Hz spectral presence and the absence of a significant 60 Hz spectral presence indicates the MTSD's presence within an aircraft and the absence of a significant 400 Hz spectral presence and the presence of a significant 60 Hz spectral presence indicates the MTSD's presence outside an aircraft. In this embodiment, the system may further include a pressure sensing system used to correlate RF emission data with pressure data for enhancing recognition of MTSD presence within or outside an aircraft. Similarly, the aircraft detection system may also combine spectral data with location information received from the monitoring system to enhance recognition of the MTSD at or away from an airport. Similarly, the aircraft detection system may evaluate spectral data with acceleration/vibration data for enhancing recognition of MTSD presence within or outside an aircraft.

In yet another embodiment, the aircraft detection system may also include at least one audio sensor wherein spectral data is correlated with audio data from jet engine noise to enhance recognition of MTSD presence within or outside an aircraft.

In summary, the aircraft detection system may include any one of or a combination of a pressure sensor, spectral sensor, accelerometer and noise sensor and the data from these sensors with or without airport proximity data received from the monitoring system may be used to enhance recognition of MTSD presence within or outside an aircraft.

In another embodiment, sensor parameters can be dynamically updated during a shipment from inputs received from the monitoring system.

In another embodiment, the RF communication system includes a satellite phone transceiver for reporting location data to the monitoring system and receiving instructions from the monitoring system over a satellite phone network.

In another embodiment, a comparison of an actual position of an MTSD with permitted positions defined by a pre-determined geofence is made and the MTSD reports a security event if the pre-determined geofence is violated.

In other embodiments, the BM and CM local area network interfaces are wireless or wireless.

In another embodiment, an MTSD can communicate with an auxiliary MTSD wherein the MTSD includes a second local area network (LAN) modem for operative establishment of a LAN with the at least one auxiliary MTSD and wherein the auxiliary MTSD includes:
an auxiliary CPU;
an auxiliary LAN modem for communication with the second LAN modem; and,
at least one sensor operably connected to the auxiliary CPU;
wherein the auxiliary MTSD reports sensor data to the MTSD for reporting to the monitoring system.

In a related embodiment, the MTSD and auxiliary MTSD communicate over a MESH network.

In yet another embodiment, the invention provides a modular tracking security device (MTSD) for determining the position of a shipment and reporting the position and status of the shipment to a monitoring system, comprising:

a base module, the base module including
an MTSD central processing unit (CPU);
a radio frequency (RF) positioning system connected to the MTSD CPU, the RF positioning system including a global navigation satellite system (GNSS) receiver and a cellular network transceiver for determining the position of the MTSD based on data received from either or a combination of GNSS and cellular network data;
an MTSD power supply;
at least one sensor connected to the MTSD CPU for detecting a security event with respect to the shipment;
wherein the base module is operative to respond to a position enquiry from the monitoring system over the cellular network and to report position to the monitoring system in response to a position enquiry or a security event and wherein, in the absence of a position enquiry or security event, the MTSD is in a power save mode.

In a still further embodiment, the invention provides a modular tracking security system for determining the position of a shipment and reporting the position of the shipment to a monitoring system, comprising:
a base module including a central processing unit (CPU);
a local area network modem; and,
at least one sensor for detecting a security event with respect to the shipment;
wherein the base module is operative to report security event data and to receive and respond to command data over a local area network wherein, in the absence of a command data or security event, the base module is in a power save mode;
a position module including a position module central processing unit (CPU), a global navigation satellite system (GNSS) receiver and a cellular network transceiver for determining the position of the position module based on data received from either or a combination of GNSS and cellular network data, the position module also for relaying command data from the monitoring system to the base module over the local area network and for relaying security event data from the base module to the monitoring system wherein, in the absence of a command data or security event, the base module is in a power save mode.

Further still, the invention provides a method for automatically turning a radio frequency device having a radio frequency communication system on or off when the radio frequency device is inside or outside an aircraft comprising the steps of:
I-whilst an aircraft is on the ground,
(a) monitoring any one of or a combination of pressure data, spectral data, accelerometer data and noise data for threshold values;
(b) interpreting the data from step (a) to determine if the radio frequency device is within an aircraft; and,
(c) turning off the radio frequency communication system if step (b) determines the radio frequency device be within an aircraft;
II-whilst the radio frequency communication system is turned off,
(d) monitoring any one of or a combination of pressure data, spectral data, accelerometer data and noise data for threshold values;
(e) interpreting the data from step (d) to determine if the radio frequency device is within an aircraft; and,
(f) turning on the radio frequency communication system if step (e) determines the radio frequency device be outside an aircraft;

Still further, the invention provides a tracking and security system (TSS) comprising:
a modular tracking security device (MTSD) for determining the position of a shipment and reporting the position and status of the shipment to a monitoring system, the MTSD including:
   a base module, the base module including a central processing unit (CPU),
   a radio frequency (RF) positioning system including a global navigation satellite system (GNSS) receiver and a cellular network transceiver for determining the position of the MTSD based on data received from either or a combination of GNSS and cellular network data;
   at least one sensor for detecting a security event with respect to the shipment and wherein the base module is operative to respond to a position enquiry from the monitoring system over the cellular network and to report position to the monitoring system in response to a position enquiry or a security event wherein, in the absence of a position enquiry or security event, the MTSD is in a power save mode.
wherein the monitoring system can request and receive position data from the MTSD and receive security event data from the MTSD.

### BRIEF DESCRIPTION OF THE DRAWINGS

The invention is described by the following detailed description and drawings wherein:

FIGS. 1, 1A, 1B, 1C and 1D are schematic bubble diagrams features and components of a tracking and security system (TSS) in accordance with the invention;

FIG. 2 is a schematic diagram of a tracking and security system in accordance with one embodiment of the invention;

FIG. 2A is a schematic diagram of a base unit of the modular tracking and security system and representative sensor modules in accordance with one embodiment of the invention;

FIG. 2B is a schematic diagram of a base unit and communications module of the modular tracking and security system and representative sensor modules in accordance with one embodiment of the invention;

FIG. 3 is a perspective diagram of a modular enclosure of the modular tracking and security system in accordance with one embodiment of the invention;

FIG. 3A is a perspective diagram of a modular enclosure of the modular tracking and security system with expansion compartments in accordance with one embodiment of the invention;

FIG. 4 is a schematic diagram showing the altitude and cabin pressure profile of an aircraft during taxiing, take-off, flight, landing and taxiing;

FIG. 4A is a representative plot of pressure and time for various aircraft taking off and landing at different airports;

FIG. 5 is a schematic diagram of one embodiment of the modular tracking and security system in accordance with a further embodiment of the invention; and,

FIG. 6 is a schematic diagram of one embodiment of the modular tracking and security system in accordance with yet another embodiment of the invention.

### DETAILED DESCRIPTION

In accordance with the invention and with reference to the figures, a tracking and security system (TSS) 10, modular tracking and security device (MTSD) 12 and method of monitoring the MTSD are described.

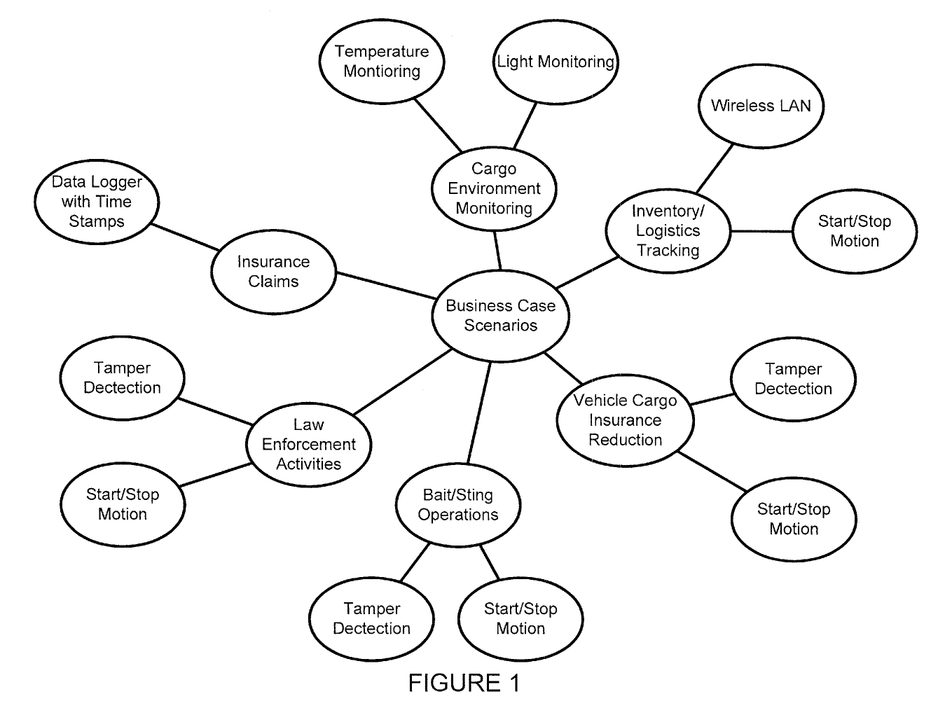

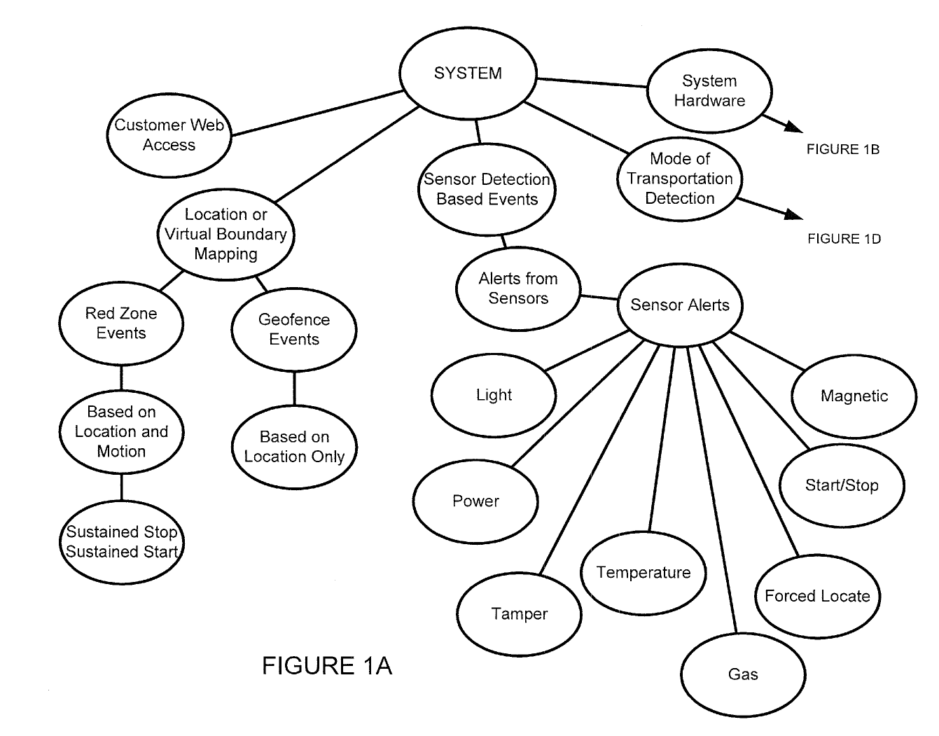

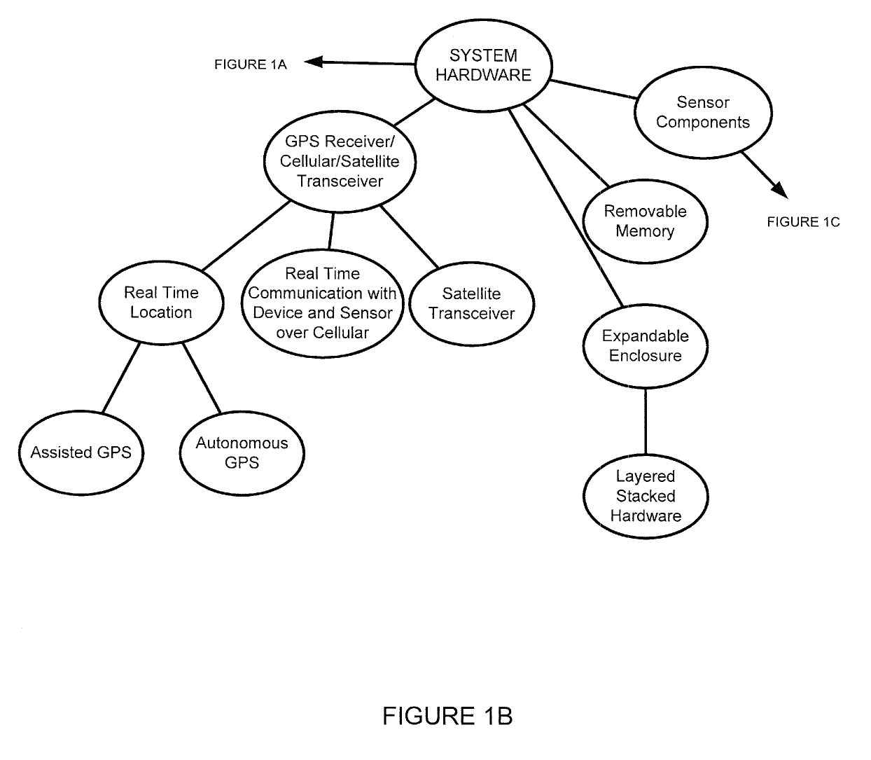

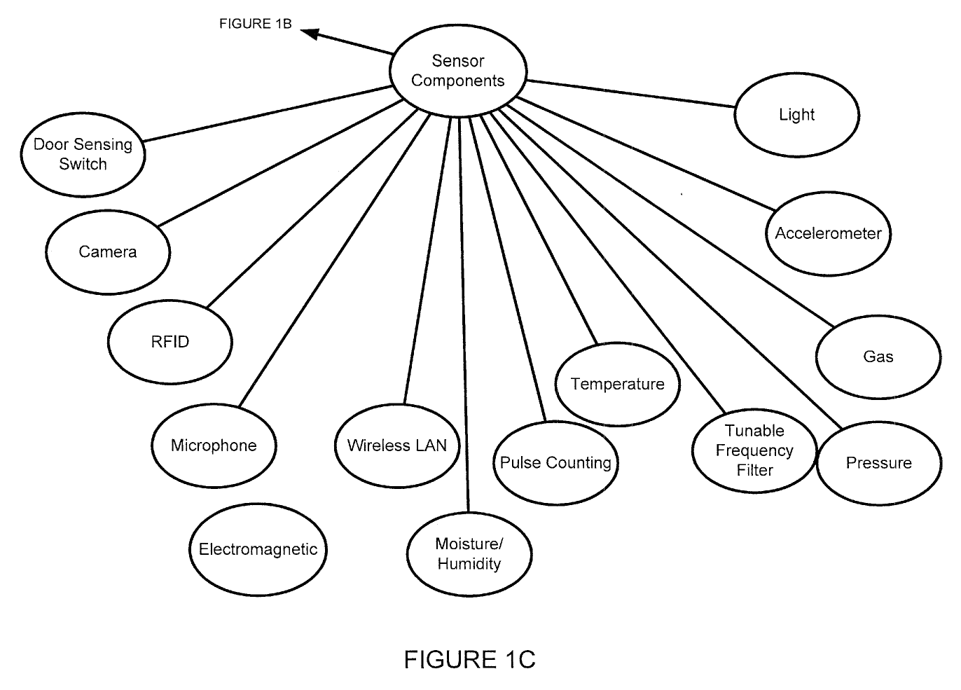

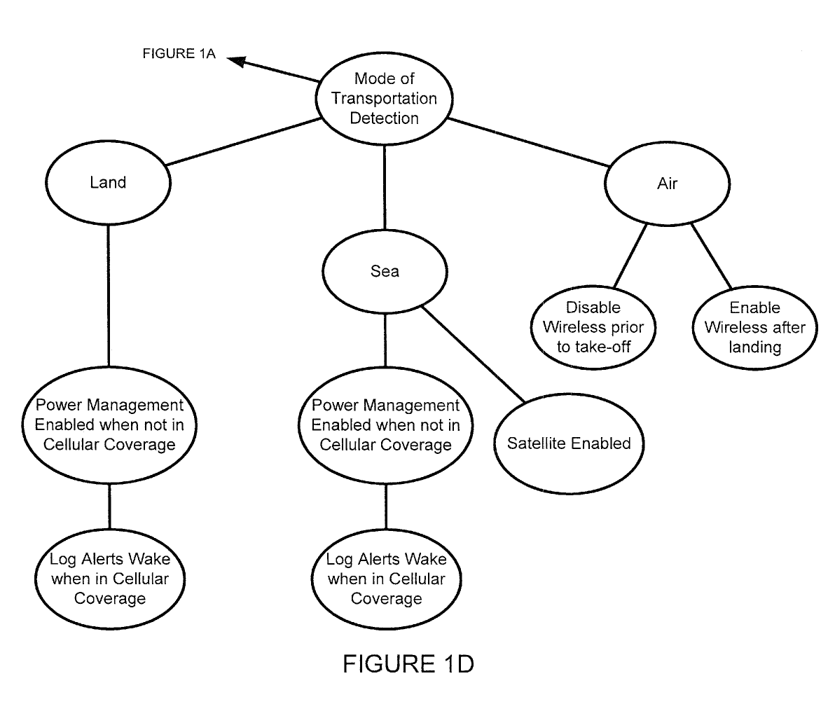

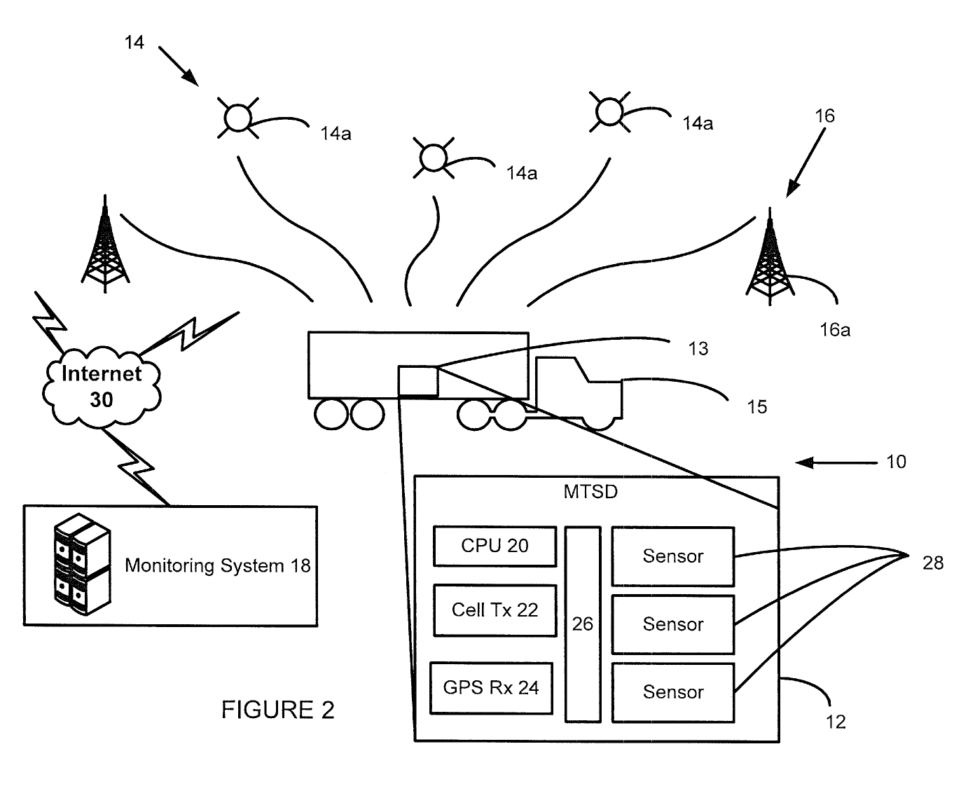

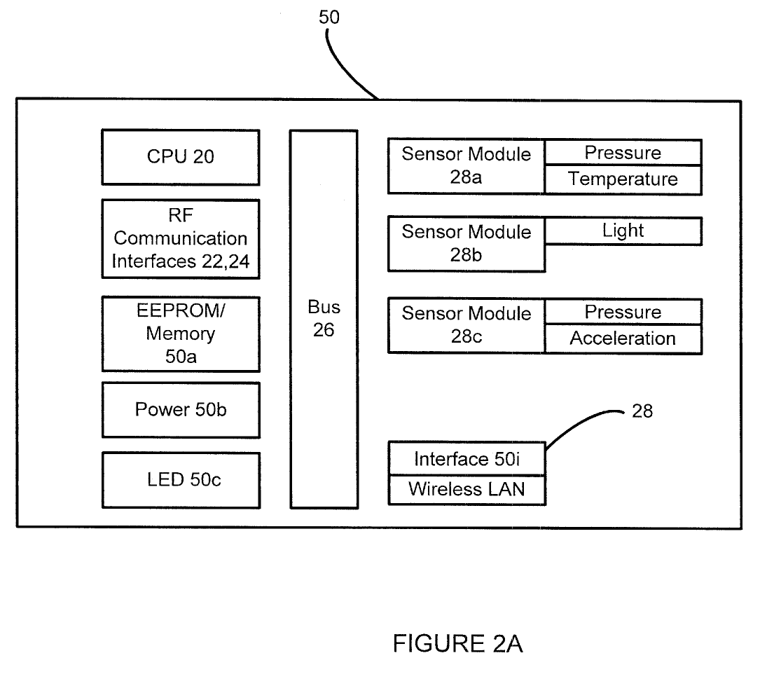

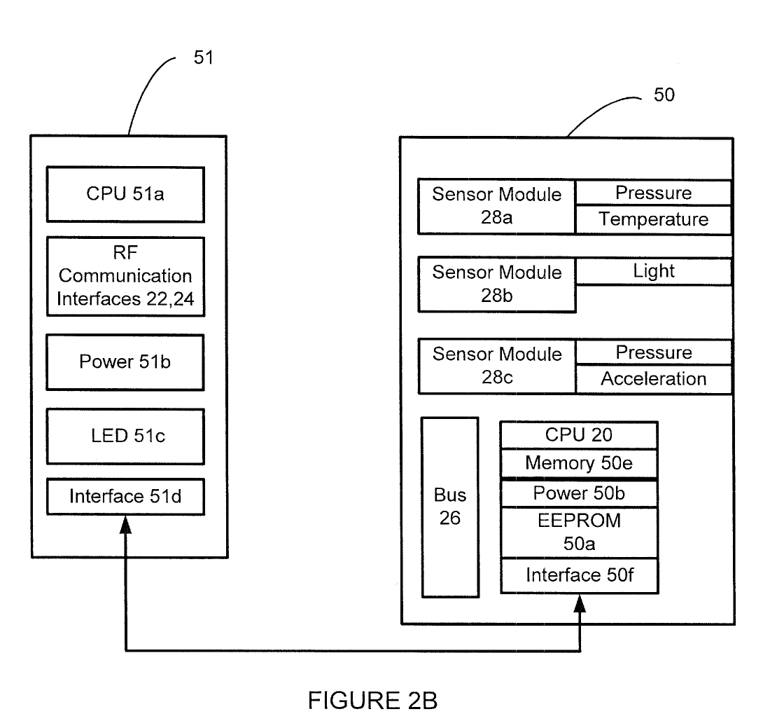

FIGS. 1, 1A, 1B, 1C, 1D and 2 provide an overview of the functions, deployment and hardware of the TSS 10. FIG. 1 shows various business scenarios in which the TSS may be deployed including cargo environment monitoring, inventory/logistics tracking, vehicle cargo insurance reduction, bait/sting operations, law enforcement activities and insurance claims. Representative examples of possible sensors that may accompany such business scenarios are also shown.

FIG. 1A shows a schematic overview of the main functions of the TSS including enabling customer web access, location or virtual boundary mapping and sensor detection events.

FIGS. 1B and 1C show an overview of the MTSD system hardware including a GPS receiver/cellular/satellite transceiver, an expandable enclosure, memory and sensor components.

FIG. 1D shows an overview of the mode of transportation detections functions for each of land, sea and air transportation.

FIG. 2 shows that the TSS includes at least one MTSD 12 adapted for containment within a shipment 13 within a vehicle 15 and for operative communication with a global navigation satellite system (GNSS) 14 (such as the global positioning system (GPS)), cellular network 16 and monitoring system 18 via assisted-GPS technologies.

In the context of this description, assisted- or aided-GPS is generally described as technologies that utilize both GNSS data and cellular data that in combination can enhance the ability to determine an accurate position in a greater number of circumstances. Generally, the ability to obtain and utilize GNSS data is limited by any interfering structures/objects (such as trees, buildings or other structures) between the GNSS receiver and GNSS satellites. The ability to obtain and utilize cellular data is less limited by such interfering structures but is limited by the availability of the cellular networks. Assisted GPS (such as GPSOne™, (Qualcomm) technology) generally operates in one of four modes. These include:
a) a standalone mode in which only GPS satellite signals are used to establish position;
b) a mobile station based mode in which both GPS signals and a location signal from a cellular network are utilized to determine position;
c) a mobile station assisted mode in which both GPS signals and a location signal from a cellular network are obtained and wherein such information is relayed to a network server, which then uses a combination of signal strength data and the GPS data and location signal to determine position; and,
d) a mobile station assisted/hybrid mode which is the same as the mobile station assisted mode but that enables full network functionality in regards to voice and data communications.

As shown in FIG. 2, the MTSD includes a CPU processor 20, cellular transceiver 22, GNSS receiver 24, and bus 26 for operative connection with at least one sensor 28.

In operation, the MTSD 12 receives and interprets either or both of GNSS data from two or more GNSS satellites 14a and cellular network data from two or more cellular towers 16a to determine the geographical location of the MTSD in accordance with assisted-GPS methodologies. In each case, the MTSD CPU receives and optionally stores the position data. The position data as obtained by the MTSD CPU 20, is reported to the monitoring system 18 over the cellular network and internet 30 a) when queried by the monitoring system, b) when a threshold event is detected and/or c) at pre-programmed time intervals.

In a preferred embodiment, the MTSD is modular and includes a base module 50 as shown in FIGS. 1C and 2A that may be configured with a number of different sensors or sensor packages 28a, 28b, 28c via a bus 26 and serial interface 50i. In addition to the CPU 20, and RF communication modules 22, 24, the base module includes appropriate EEPROM/Memory 50a and a power module 50b. Optional features such as an LED output 50c and a wireless LAN interface may also be included. Collectively, the base module functions to:
receive and interpret GNSS signal data;
receive and interpret cellular network signal data;
determine the strength and validity of GNSS and cellular network signals;
interpret position on the basis of both the GNSS or cellular network signal or a combination of both signals;
wake up and report position when queried by the monitoring system through the cellular network;
wake up and report security events and position if threshold conditions are detected within the MTSD;
generally minimize power usage by operating in both a power-on and power-save mode;
generally minimize air-time usage by only communicating over the cellular networks when requested or when a security event occurs;
turn-off all RF components when in an aircraft to operate in an airborne aircraft mode;
compare actual position with permitted positions defined by a pre-determined geofence;
communicate with and recognize a variety of sensors and sensor combinations and associated thresholds when configured to the base module;
store multiple pre-programmed and threshold events within the base unit CPU/EEPROM/Memory; and,
optionally allow threshold events to be configured over the air.

Within the MTSD, the power module 50b provides power to all sensors, the GNSS receiver and cellular network transceivers. The power module delivers power as determined by the operating status of the base module. That is, if the base module is operating in the power-save mode, minimal power is consumed to maintain the CPU functions of receiving cellular network data and sensor operation. The MTSD will switch to full power mode if and when a position enquiry is received, a security event is to be reported to the monitoring system or in accordance with a pre-established schedule.

The serial interface 50i allows different sensors and sensor combinations to be configured to the base module 50 through bus 26.

The LED Output module 50c functions to provide visual output regarding the status of the battery and MTSD.

### Sensors

As shown in FIGS. 1C, 2, 2A and 2B, various sensors and combinations of sensors may be configured to the base module. Such sensors may be selected from any one or a combination of the following non-exclusive list of sensor types. It is understood that each “sensor” may include an appropriate printed circuit board(s) and associated programming that receives and interprets raw signal/data for delivery to the base module in an intelligible form:

light sensors

pressure sensors

acceleration sensors

temperature sensors

moisture sensors

radiation sensors

vibration sensors

magnetism sensors

strain sensors

switch sensors

camera

radio frequency identification (RFID) sensors

sound sensors

electromagnetic sensors

Wireless LAN

gas sensors

tunable frequency sensor

For most cargos, the detection of light and/or the violation of a Geofence are utilized as the two primary indicators of a security event. That is, the opening of a package to expose the contents of a shipment to light and/or the detection of movement of the package to an unauthorized position, both singularly and/or collectively, provide the most definitive indicator(s) of a security event(s) for most cargos. However, as noted above, depending on the specific security requirements of a particular cargo, the system may be adapted to monitor any combination of security events as would be understood by one skilled in the art.

As shown in FIGS. 1C, 2, 2A and 2B, various sensors may include for example a pressure and temperature sensor package 28a, a light sensor package 28b, pressure and acceleration sensor package 28c, and/or an optional auxiliary base unit 28d that may be included to enhance the base functionally of the base unit 50.

As shown in FIG. 2B, in a preferred embodiment, the MTSD 12 includes separate and discrete sub-systems namely a communications module 51 and base unit 50. By providing separate and discrete sub-systems, the communications module and base unit may be physically separated from one another. As such, a communication module can be easily connected and disconnected from the base unit in order to substitute or connect another communication module having slightly different functions or simply to replace a communication module. In addition, by being able to physically separate the CM and BM from one another, the operability of the system may be enhanced by being able to locate the CM at a physically distinct location to the base module which may be desirable to provide enhanced data collection functions of the system. In this embodiment, the communications module (CM) 51 includes a CM CPU 51a, the RF communication interfaces 22, 24, a CM power module 51b, LED 51c and CM interface 51d. The base unit 50 includes one or more sensor modules 28a, 28b and/or 28c, CPU 20, EEPROM 50a, power module 50b and interface 50f. The CM interface 51d and interface 50f are operably connectable to one another by either a wired or wireless system.

For each of the embodiments as shown in FIGS. 2 and 2A, the system provides an intelligent system of power management by commanding the RF communications systems to “sleep” under appropriate conditions. During “sleep”, the RF communications systems are incapable of acting on signals from the cellular network and are in a power save mode. The RF communications system is brought out of a sleep or power save mode following receipt of an appropriate command from the main system CPU. In one embodiment, the RF communications systems is instructed to power up by momentarily applying power to battery charger inputs within the RF communications system such that the RF communication system believes it is being connected to AC power which causes it to wake up. Alternatively, a signal pin may be utilized to turn the RF communication system on in another embodiment.

### Modular Enclosure

In order to provide the greatest flexibility to enable the MTSD to be adapted to the specific security requirements of a particular shipment, the base module 50 (as described schematically in FIG. 2B) and sensors are preferably adapted for modular expansion around the base module.

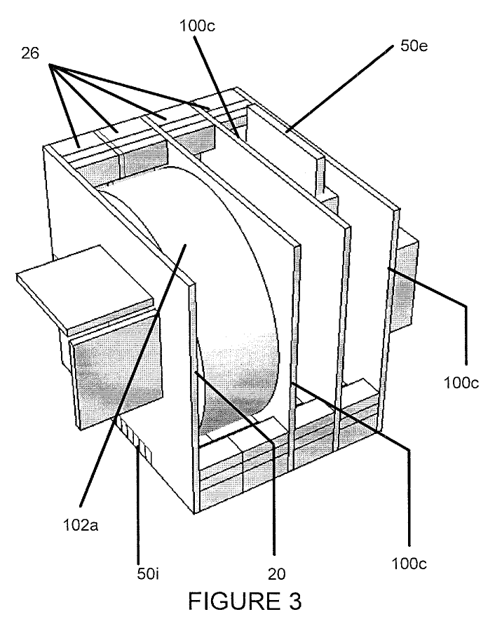

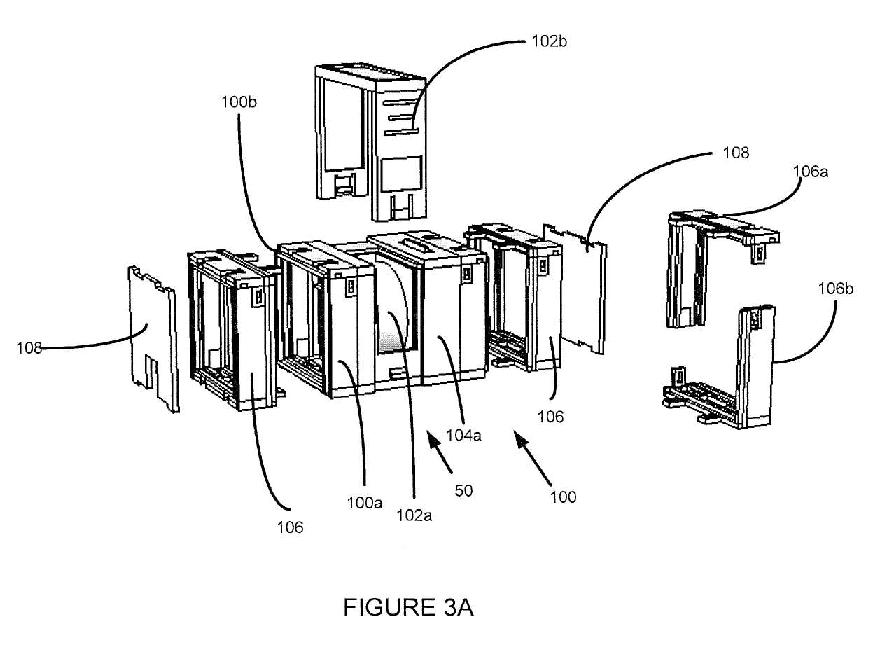

As shown in FIGS. 3 and 3A, the base module is housed within an enclosure 100 including a battery compartment 102 to contain a battery 102a and an electronics compartment 104 to contain the CPU 20. The CPU is operatively connected to a serial interface 50a for connection to a separate communications module. As shown, the enclosure 100 includes a base 100a, a back 100b wherein the base and back enable an appropriate printed circuit board(s) (PCB) 100c supporting CPU, memory 50e and sensor electronics to be operatively contained within the electronics compartment with appropriate connectors being exposed to the exterior of the enclosure.

As shown in FIG. 3A, the electronics compartment 104 is covered by a cover 104a. The battery compartment 102 includes a battery cover 102b that can be readily removed to enable exchange and replacement of a battery.

It is preferred that the enclosure is transparent or translucent to enable those MTSDs configured with light sensors to allow light penetration within the enclosure.

As shown in FIG. 3A, if additional sensor arrays are to be configured, one or more expansion compartments 106 may be extended from the base enclosure 100. As shown, each expansion compartment is provided with appropriate mating surfaces between the base enclosure and one or more expansion enclosures permitting the MTSD to be expanded to accommodate the desired combinations of sensor arrays. Each expansion compartment 106 may be comprised of corresponding mating side walls 106a, 106b so as to enable the containment of each sensor array. End plates 108 are provided to provide appropriate covering to the end compartments.

### Aircraft Sensor

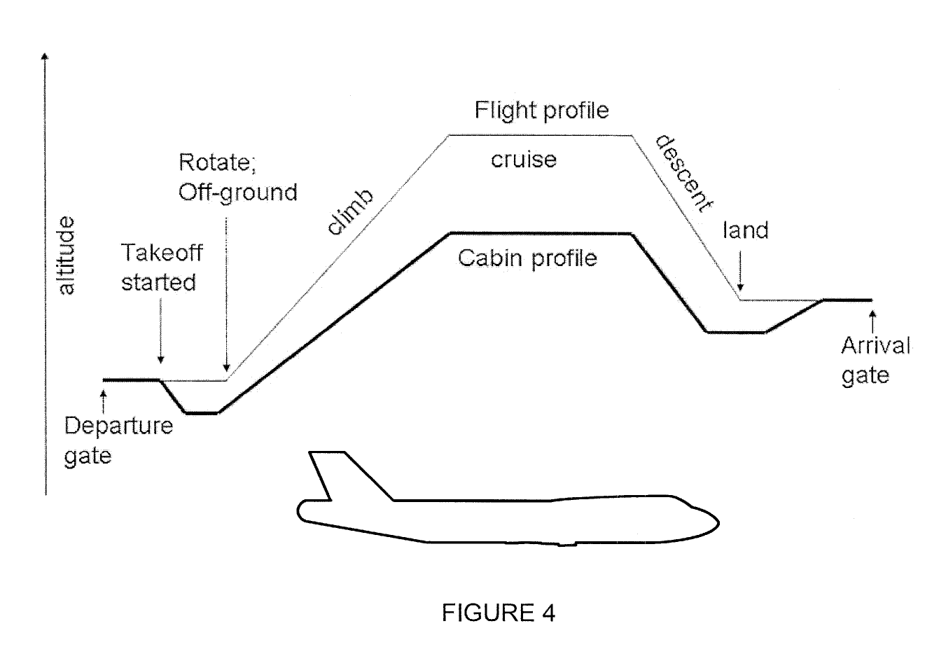

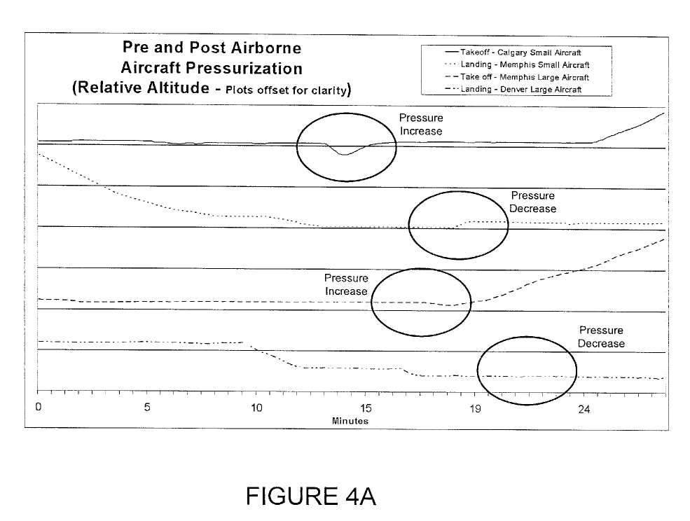

In a preferred embodiment, the MTSD is specifically adapted to ensure that the transceiver/receiver functions of the MTSD are turned off whilst inside a pressurized aircraft. As shown in FIG. 4, in many pressurized aircraft, the aircraft are automatically slightly pressurized above local atmospheric pressure during both take-off and landing of the aircraft. The upper line in FIG. 4 shows the altitude profile of an aircraft from take-off to landing whereas the lower line shows the cabin pressure relative to the altitude.

The process to pressurize the aircraft is usually initiated by the position of the throttles of the aircraft. The pressurize signal is generally a throttle position higher than the throttle position that would normally be used on the taxiway. During the take-off roll, the pressure increase will normally correspond to an approximately 0.1 to 0.3 pounds per square inch (PSI) increase above the air pressure on the ground before the aircraft doors were closed. The purpose of the slight pressurization is to reduce the ‘pressure bump’ that would otherwise occur during climb and also for safety reasons, wherein, should a fire occur; the slightly pressurized cabin may delay the entry of fire into the cabin.

Aircraft in flight are typically pressurized to the equivalent pressure of 8,000 feet (10.91 PSI) or less. Some aircraft use 6,000 feet (11.78 PSI), for example. The lower the equivalent altitude the more comfortable it is for passengers.

Aircraft are also automatically slightly pressurized upon landing. The increased pressurization during landing is usually automatically initiated by the engagement of the landing gear. Again, the pressure increase generally corresponds to approximately a 0.1 to 0.3 PSI increase above the air pressure on the ground of the landing field. The air pressure on the ground at the landing field is automatically provided to the aircraft by the air control system. The reasons for increasing the air pressure during landing are the same as for take-off, namely to minimize the ‘pressure bump’ and for fire safety reasons.

In a preferred embodiment, the MTSD is configured to determine when a pressurized aircraft has initiated takeoff and has landed in order to ensure that the MTSD is operating only when the aircraft is not airborne. Within this embodiment, the system is programmed to detect an increase in air pressure during take-off and a decrease in air pressure during landing to provide an appropriate on or off signal to a configured MTSD. The pressure signals are filtered and integrated such that scaling, trend monitoring and integration periods are dynamically altered and compared to an appropriate configurable threshold either above or below that threshold.

Such features are particularly important to ensure that changes in atmospheric pressure to the sensors are not falsely interpreted to be aircraft take-off or landing events in other situations. For example, the filtering and processing of pressure data is made to exclude pressure events that could be experienced within a truck container driving along roads (particularly mountain roads) with particular rises and drops that result in discernable pressure changes within particular periods of time.

As such, in another preferred embodiment, the sensor array includes an accelerometer to detect the acceleration of take-off or deceleration of landing which if combined with detection of air pressure provides greater certainty in activation or deactivation of the MTSD.

More specifically, in a preferred embodiment, detected motion triggers a higher rate of pressure sensor sampling. That is, the typical pressure sampling rate will be at a less frequent rate (such as 20 seconds) but is adjusted to a faster rate (such as 5 seconds) in the presence of motion. The 5 second rate continues for a settable period wherein the system is hunting for a rate of pressure change in excess of a threshold value that corresponds to the pre-lift off pressurization change as shown in FIG. 4. This pressurization change is marked as “take-off started” in FIG. 4.

This rate threshold approach works best in smaller aircraft where the volumetric capacity of the aircraft fuselage does not filter the rapid pressure change. In the smaller aircraft, rates in excess of 24 pa/sec or 0.0035 PSI/sec (equivalent to vehicle traveling at 100 km/hr or 62 MPH—on a road way with a grade of 8%) are detectable. In larger aircraft, the fuselage volumetric capacity acts as a filter and pressure changes are significantly subdued. As a result, rate of pressure change and or depth of the change as detection variables is usually insufficient to distinguish pre-takeoff and post landing status. FIG. 4A shows typical pressure profiles measured for each of small and larger aircraft landing and taking off. Particular attention is drawn to the upper plot where a pressure increase prior to take-off was not maintained prior to take-off which is representative of the need for further sensory inputs to provide greater certainty.

Accordingly, to improve take off detection and landing status, any of the following combinational sensory inputs can be used to determine airborne status and shutting down the communications module (modem):
i) On detection of an increase in pressure (set to a lower limit associated with large aircraft) in excess of a rate equivalent to 2% grade traveling at 100 km/hr (62 miles/hr) (6 Pa/sec or 0.00087 psi/sec), the sensor forces a location report along with an airport proximity request packet to the host for a airport proximity analysis to be made. The host then instructs the sensor to shutdown, if the sensor is within a pre-determined distance of an airport (xx meters) or provides a distance calculation to the nearest airport. If an aviation shutdown command is sent, the sensor shuts down the modem and remains shutdown for a period of time. During this aviation shutdown interval, the sensor is tracking pressure to determine if the aircraft has in fact become airborne. If lift off is not achieved during the aviation shutdown interval and upon elapse of this interval, the modem is turned back on and a host aviation notification (forced locate and airport proximity request) is once again repeated. Should alarms occur during the interval, the modem is turned on and an alarm message is processed (sent to the monitoring system/host) and resumes its aviation shutdown, all the while sensing take-off pressure. If take-off is detected, the modem is shut down immediately.
   For aircraft landing detection the pressure profile is monitored, with the objective to turn on the modem once again when aircraft landing is detected. This is achieved by monitoring and detecting a sustained increase pressure (descent) and a transition below the elevation of a reference high altitude airport (eg. the Denver Airport (5300 feet)) as the 1^{st} detectable stage in an aircraft landing pattern. Secondly, once landing detection is engaged and maintained the sensor looks for a pressure decrease (effectively an ascent) which is linked to the post landing pressurization inside the aircraft. The rate of pressure change (an increase) is measured. This pressure increase must be followed by a period of accelerometer inactivity (lack of vibration—no motion) which occurs after the aircraft has landed, has parked and is being prepared for unloading. Failing detection of the appropriate pressure rate increase, a sustained period of inactivity after the 1^{st} detectable landing stage also represents that the aircraft has landed and that it is then safe to turn the modem back on.
ii) An alternative approach for pre-lift off detection uses RF detection as a means of determining location within an aircraft. In this case, RF emission presence of 400 Hz and an absence of 60 Hz provides a unique and effective sensory input. By way of background, these emissions are unintentional radiation and considered electrical noise present as a result of power systems within building and warehouse complexes (60 Hz) and within aircraft (400 Hz). In this embodiment, the sensor looks for significant spectral presence for both fundamental and harmonic frequencies as appropriate to make a signal detection determination. Emission absence/presence by themselves is a clear indicator that the package is inside an aircraft and away from a terminal loading port which implies that the aircraft is ready for liftoff and that the modem must be shutoff.
   In another related embodiment, the absence/presence of these emissions can also be monitored in conjunction with a pressure measurement for definitive pre-lift off detection in that all pressure increases are now isolated as aviation pressure changes and processed as such.
   Yet another approach algorithmically couples the absence/presence of these emissions with GPS information from a database of known airports (as described above) for a definitive pre lift off detection in which case, upon pre-lift off detection, the modem is shut down.
   On landing the reverse scenario is detected by measuring the absence of 400 Hz and presence of 60 Hz after the 1^{st} detectable landing stage has been identified in order to turn the modem back on.
iii) Another approach uses measurement of acceleration with expectation that this occur on flat terrain (X, Y, Z vector analysis) as found on a runway. Acceleration must be sustained to achieve a configurable velocity in excess of 240 km/hr or 150 mph. Acceleration analysis occurs in a window time frame after a pressure increase is detected as is the case of pre-lift off pressurization. Upon pre-lift off detection, the modem is shut down.
   Aircraft landing detection is achieved by sensing deceleration followed by a pressure decrease and/or a configurable motionless period after the 1^{st} detectable landing stage described above in order to turn the modem back on.
   Vibration (measured by an accelerometer) on landing or take-off may also be an effective input parameter.
iv) Yet another approach uses measurement of audio to sense a significant increase in audio amplitude and/or spectral content representing jet engine noise. Upon pre-lift off detection the modem is shut down. The reverse scenario is true for landing detection. The absence of audio amplitude and/or spectral content is indicative that the aircraft has landed.
   Audio analysis for pre lift-off and post-landing can be algorithmically coupled to pressure measurement, 400 Hz, accelerometer signals and GPS (for pre-lift-off) as discussed above.
v) in yet another approach, and as a back-up mechanism to ensure that during flight, the modem is shut down, the pressure profile is maintained and a sustained pressure decrease and achieved altitude (in excess of the airport elevation at a high altitude reference airport) are monitored as a back up mechanism to any or all of the above sensory input algorithms to ensure the modem is turned off during flight.

It should also be noted that one issue associated with proper landing detection is a situation where aircraft are requested to maintain a holding pattern as a result of airport congestion in and about and above or near an airport. In some instances, a holding profile looks much like a normal landing profile at an airport of higher elevation than the airport the aircraft is planning to land at. As such, it is generally insufficient to rely on a sustained descent to determine landing and or ascent after the 1^{st} detectable landing stage. As a result, correct landing detection should be accompanied by a period of sustained motionless inactivity. Similarly other irregularities include in flight pressure adjustments which can likewise give rise to an incorrect conclusion of airborne status.

As is understood the pressure sensing system may be adapted for use with other electronics devices such as personal electronic devices (PEDs).

### Other Features

In further embodiments, the MTSD may include additional processing and memory capabilities to enhance the functionality of the MTSD. Such embodiments may incorporate additional hardware/software to enable increased data storage and processing, local area networking of various MTSDs, additional interfaces for retrieving data or updating system software, etc.

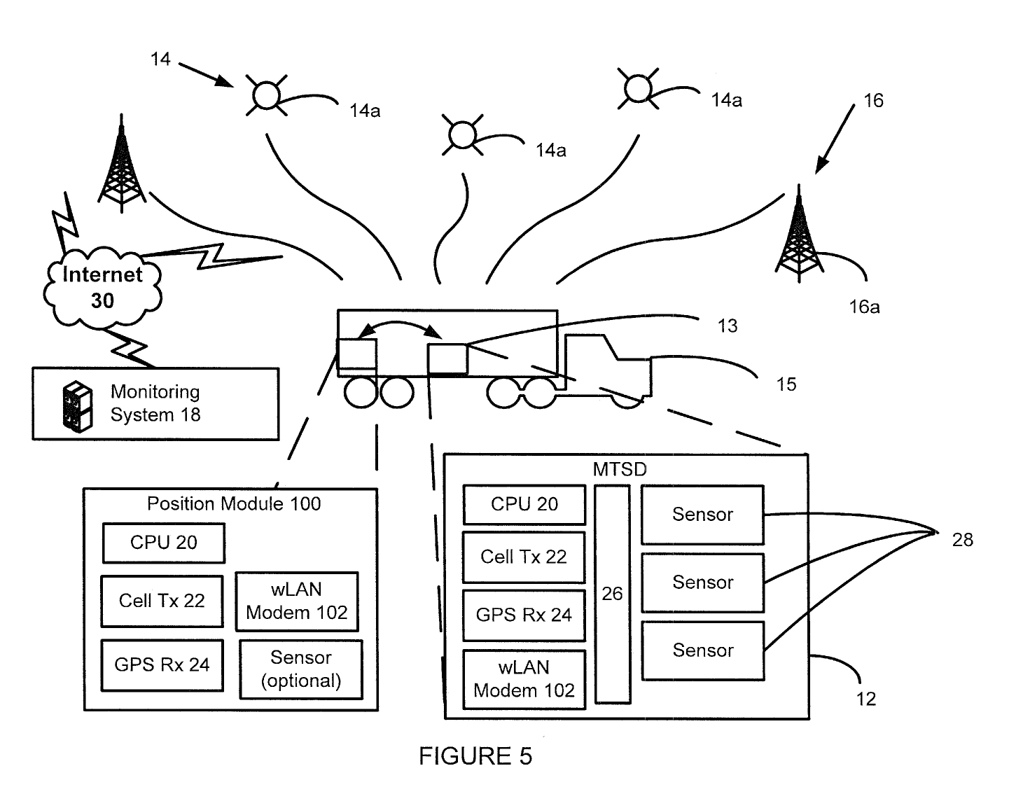

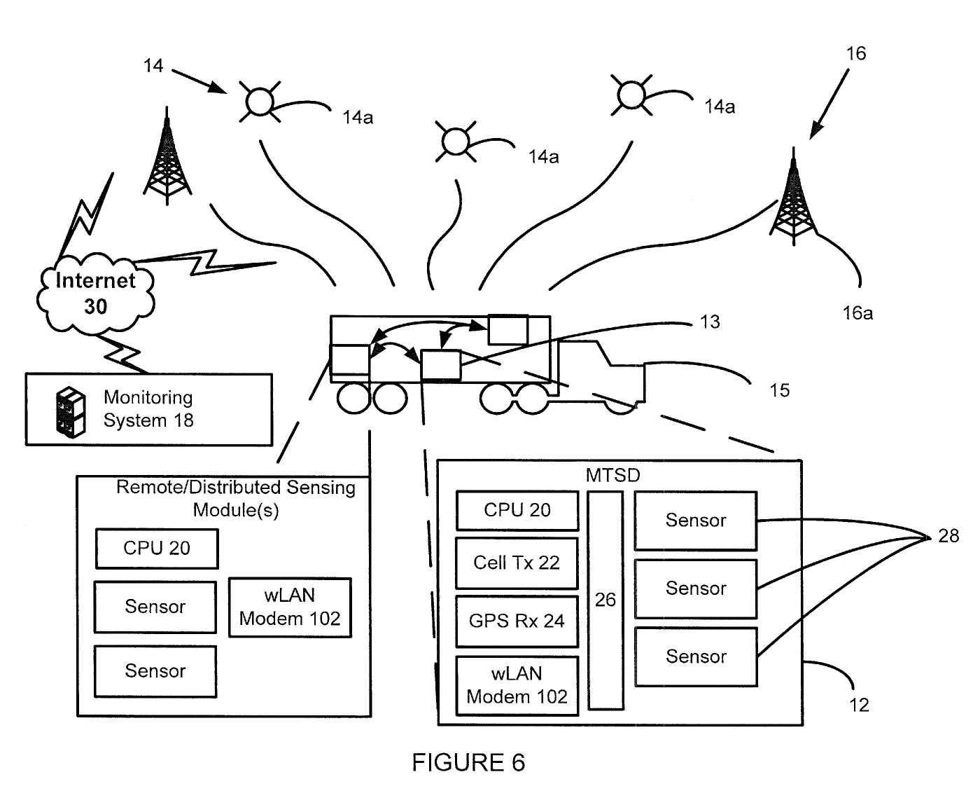

With reference to FIGS. 5 and 6, further embodiments as described above in relation to FIG. 2B are shown wherein one or more MTSDs are configured to a wireless local area network (WLAN) such that the position locating hardware may be located in a more favorable position within the shipment to a) enhance the ability of the system to obtain meaningful position data from the GNSS and cellular networks, b) to sense different events at different locations within the shipment and/or c) to monitor different events from different packages within the shipment.

As shown, a separate position module 100 may be located near or on the exterior of a shipment container. The position module includes a CPU 20a together with a cellular transceiver 22 and GNSS receiver 24 and optional sensor(s). In this embodiment, the MTSD would also include a WLAN modem 102 for operative communication with the position module 100 with hardware known to those skilled in the art. Suitable WLAN protocols would include those such as 802.15.4 and others as known. The position module CPU 20a operates to relay all security event data received from each MTSD and/or all other status data back to the monitoring system together with position data the position module has determined. Similarly, the position module relays all commands directed to specific MTSDs received from the monitoring system to the individual MTSDs.

Alternatively the system in FIG. 5 could also include a local area network (LAN) or other wired interface (eg: USB) operating as a wired LAN replacing modem 102 for communication with one or more MTSDs similarly equipped with a wired LAN or other wired interface (eg: USB) also replacing modem 102 and optionally a wireless LAN within the shipment container to communicate with the balance of wireless MTSD or distributed sensors.

With reference to FIG. 6 a further embodiment of the invention is shown wherein one MTSD incorporates a wireless local area network (WLAN) such that other wireless sensors can be distributed throughout the transport carrier within packages of a common shipment a) to sense different events at different locations within the shipment and/or b) to monitor different events from different packages within the shipment. Such a deployment may utilize MESH networks.

Multiple MTSDs may exist within a transport entity. Importantly, the relationship between these devices may be that they are not related to each other as the shipments are customer centric and belong to different customers.

Alternatively, a shipment containing two MTSD's from the same customer could be further optimized in a similar configuration as that related to the scenario in FIG. 5 except that the 2^{nd} separate position module 100 and the main MTSD both have network and GPS coverage as shown in FIG. 5. In this case, there are redundant components and one of the two devices can be selected as the primary MTSD and act as a gateway for the other MTSD thereby reducing network communication and associated air and location costs.

In the specific case of shipments by sea, where a cargo may be out of range of a cellular network for long periods of time, one embodiment of the invention incorporates the use of satellite phone technology to report position and/or security data back to the monitoring system. In this case, the embodiment as shown in FIG. 5 may be configured to include a satellite phone transceiver.

### User Interface

The user interface enables each of the consignors, consignees and shipping company to intelligently monitor the movement of a specific cargo by enabling:

location queries on demand;

status inquiries on demand;

dynamic adjustment of sensing parameters;

status reports in the event of a threshold event.

Table 1 shows a representative transaction report that can be generated from the system.

TABLE 1
Representative Transaction Report

| # | Asset | Action | Details | Status | Created Time | Received Time |
|---|---|---|---|---|---|---|
| 1 | Trailer 21 089123 | Position | Assisted | Success | 2008-06-06 | 2008-06-06 |
| | | Delivery | GPS Fix | | 14:50:45 | 14:50:46 |
| 2 | Trailer 21 089123 | Temperature | T = 15 | Success | 2008-06-06 | 2008-06-06 |
| | | Sensor Status | | | 14:50:49 | 14:50:51 |
| 3 | Trailer 21 089123 | Tamper | False | Success | 2008-06-06 | 2008-06-06 |
| | | Sensor Status | | | 14:50:49 | 14:50:51 |
| . . . | . . . | . . . | . . . | . . . | . . . | . . . |
| N | Trailer 21 089123 | Position | Assisted | Success | 2008-06-06 | 2008-06-06 |
| | | Delivery | GPS Fix | | 14:50:55 | 14:50:58 |

### System Features, Advantages and Representative Examples

The system enables the owner of a package to track the location and status of a package during all phases of the shipping cycle over a wide area network across all regular forms of shipping including rail, truck, air and sea transportation. As such, the subject system is highly adaptable in that the system does not care what form of transportation is being utilized at a given moment during the shipping cycle because the system has the ability to adapt to specific carrier conditions to save power and/or turn on or turn off features upon recognition of specific conditions.

As such, the system has the ability to be adapted to any number of cargos and provide considerably greater flexibility and hence, information to interested parties. These interested parties include consignors, consignees and shipping companies and various third parties having an interest in the shipment. This ultimately contributes to an enhanced level of security for such cargos as a greater number of potential events can be established and monitored for a specific cargo. Moreover, the system is adaptable to a number of other applications besides shipping such as law enforcement and insurance.

The flexibility and capabilities of the system are illustrated by means of the following representative examples.

### Pharmaceutical Shipment

In one cargo-monitoring scenario, temperature-sensitive loads of pharmaceutical products are shipped from a manufacturing warehouse by truck, inside a trailer equipped with a refrigeration unit that ensures the load is maintained within an acceptable temperature range. The cargo is taken to, and unloaded at, a storage area or transportation hub/depot. In this instance, with the use of an MTSD having temperature sensors, the cargo temperature is monitored during the shipment, and notifications to the customer are generated for any temperature deviations outside of the acceptable temperature range. For every notification generated, the location of the device is also determined via assisted-GPS methods utilized by the tracking device despite the severe wireless coverage impairment caused by the enclosure unit (i.e., refrigerated trailer). By knowing the location of the cargo/trailer and the type of notification received, the customer is then able to act upon the event accordingly, should this type of event take place.

### Cigarette Shipment

In another cargo security monitoring scenario, the invention is discretely placed inside a trailer-load of cartons of cigarettes. In this instance, ensuring that the trailer doors remain closed until it arrives at the destination address is critical, as premature opening of the doors would most likely indicate a theft is occurring. With the use of the tamper detection feature of the invention (eg. light and/or door switch sensors), any and all events where the trailer doors are opened would cargo-tamper trigger notifications to the user. For every notification, the location of the device is also determined via assisted-GPS methods utilized by the tracking device despite the severe wireless coverage impairment caused by the enclosure unit (i.e., trailer) and its contents (foil wrapped cigarette packages). Knowing the location of the trailer and the type of notification received, the customer is then able to act upon the event accordingly, should this type of event take place. Likewise, MTSDs can be located within individual boxes within the shipment such that, should a theft occur, will enhance the ability to recover of stolen product.

### Bait

In another cargo-security monitoring scenario, the invention is placed inside an empty cardboard box or package (that is, a “bait” package) that would otherwise contain valuable jewelry or personal electronic equipment. In this instance, ensuring that the box remains unopened until it has arrived at the destination address is critical, as premature opening of the box would most likely indicate that there is intent to steal the perceived contents of the box. With the use of the tamper detection feature of the invention, any and all events where the package is opened shall trigger package-tamper notifications to the user. For every notification, the location of the device is also determined via autonomous-GPS or assisted-GPS methods utilized by the tracking device. Knowing the location of the package and the type of notification received, the customer is then able to act upon the event accordingly, should this type of event take place.

Although the present invention has been described and illustrated with respect to preferred embodiments and preferred uses thereof, it is not to be so limited since modifications and changes can be made therein which are within the full, intended scope of the invention.

We claim:

1) A modular tracking security device (MTSD) for determining the position of a shipment and reporting the position and status of the shipment to a monitoring system, comprising:
a base module (BM) including:
a BM central processing unit (CPU);
a BM power supply;
a BM interface enabling one or more sensors to be selectively configured to the BM CPU;
at least one sensor operatively connected to the BM interface for detecting a security event with respect to the shipment;
a BM local area network interface;
a communication module (CM) including
a CM CPU;
a CM power supply;
a radio frequency (RF) positioning system including a global navigation satellite system (GNSS) receiver and a cellular network transceiver for determining the position of the MTSD based on data received from either or a combination of GNSS and cellular network data;
a CM local area network interface;
wherein the BM and CM are operatively connected together by the BM local area network interface and the CM local area network interface and wherein the MTSD is operative to respond to a position enquiry from the monitoring system over the cellular network and to report position to the monitoring system in response to a position enquiry or a security event and wherein, in the absence of a position enquiry or security event, the MTSD is in a power save mode.

2) A modular tracking security device as in claim 1 wherein the RF positioning system is an assisted-GPS system.

3) A modular tracking security device as in claim 1 wherein the at least one sensor is selected from any one of or a combination of light, pressure, acceleration, temperature, moisture, radiation, vibration, sound, magnetism, strain, switch, camera, radio frequency identification (RFID), electromagnetic, wireless local area network (WLAN), gas and tunable frequency sensors.

4) A modular tracking security device as in claim 1 wherein the base module includes a bus operably connected to the BM CPU enabling additional sensors to be configured to BM CPU.

5) A modular tracking security device as in claim 4 wherein the MTSD includes an enclosure for containing the base module and wherein the enclosure enables the selective attachment of one or more sensor enclosure modules for configuring additional sensors to the base module.

6) A modular tracking security device as in claim 4 wherein the BM CPU is operative to recognize the attachment of various sensor combinations to the base module.

7) A modular tracking security device as in claim 5 wherein the BM power supply is a battery operably contained within the enclosure.

8) A modular tracking security device as in claim 1 wherein the base module includes an aircraft detection system to detect the MTSD's presence within an aircraft, wherein the BM CPU switches the MTSD to an aircraft mode when the MTSD is within the aircraft prior to take-off and the RF positioning system is turned off, and wherein the aircraft detection system detects that the MTSD has landed and the MTSD CPU switches the RF positioning system to the power save mode.

9) A modular tracking security device as in claim 8 wherein the aircraft detection system detects an increase in air pressure relative to ambient pressure to signal the MTSD's presence in the aircraft prior to take-off.

10) A modular tracking security device as in claim 8 wherein the aircraft detection system detects a decrease in air pressure relative to ambient pressure to signal that the aircraft has landed.

11) A modular tracking security device as in claim 8 wherein the aircraft detection system includes at least one accelerometer configured to the MTSD for detection of acceleration or vibration that in conjunction with a pressure sensing system signals the MTSD's presence in the aircraft prior to take off and the MTSD's presence in the aircraft after landing.

12) A modular tracking security device as in claim 11 wherein the aircraft detection system monitors an increase in pressure wherein if a pressure increase is detected in excess of a threshold grade for a given acceleration, speed or vibration as determined by the at least one accelerometer causes the MTSD to report its location to the monitoring system, wherein the monitoring system accesses an airport proximity database to determine if the MTSD is within a pre-determined distance of an airport and wherein if the MTSD is determined to be within a pre-determined distance of an airport, the RF communication system is turned off.

13) A modular tracking security device as in claim 12 wherein if the RF communication system is turned off, the MTSD continues to monitor pressure to determine if the MTSD has become airborne.

14) A modular tracking security device as in claim 13 wherein if the MTSD determines that the aircraft has not become airborne after a threshold period of time, the RF communication system is turned on and the MTSD reports its position to the monitoring system to confirm that the MTSD is not at or near an airport.

15) A modular tracking security device as in claim 14 wherein aircraft landing is detected by monitoring pressure below a pressure threshold and correlating pressure data to acceleration, speed or vibration data.

16) A modular tracking security device as in claim 8 wherein the MTSD's presence in an aircraft is determined by monitoring RF emission presence of 400 Hz and an absence of RF emission of 60 Hz, wherein the presence of a significant 400 Hz spectral presence and the absence of a significant 60 Hz spectral presence indicates the MTSD's presence within an aircraft and the absence of a significant 400 Hz spectral presence and the presence of a significant 60 Hz spectral presence indicates the MTSD's presence outside an aircraft.

17) A modular tracking and security device as in claim 16 wherein the aircraft detection system further includes a pressure sensing system used to correlate RF emission data with pressure data for enhancing recognition of MTSD presence within or outside an aircraft.

18) A modular tracking and security device as in claim 16 wherein the aircraft detection system includes combining spectral data with location information received from the monitoring system to enhance recognition of the MTSD at or away from an airport.

19) A modular tracking and security device as in claim 16 wherein the aircraft detection system includes at least one accelerometer and wherein the BM CPU evaluates spectral data with acceleration/vibration data for enhancing recognition of MTSD presence within or outside an aircraft.

20) A modular tracking and security device as in claim 16 wherein the aircraft detection system includes at least one audio sensor and wherein the BM CPU spectral data with audio data from jet engine noise for enhancing recognition of MTSD presence within or outside an aircraft.

21) A modular tracking and security device as in claim 16 wherein the aircraft detection system includes any one of or a combination of a pressure sensor, spectral sensor, accelerometer, noise sensor, and the BM CPU uses any one of or a combination of pressure data, spectral data, acceleration data, noise data and airport proximity data received from the monitoring system for enhancing recognition of MTSD presence within or outside an aircraft.

22) A modular tracking security device as in claim 1 wherein the BM CPU enables sensor parameters to be dynamically updated during shipment from inputs received from the monitoring system.

23) A modular tracking security device as in claim 1 wherein the monitoring system is operably connected to the internet.

24) A modular tracking security device as in claim 1 wherein the RF communication system includes a satellite phone transceiver for reporting location data to the monitoring system and receiving instructions from the monitoring system over a satellite phone network.

25) A modular tracking security device as in claim 1 wherein the BM CPU enables comparison of an actual position of an MTSD with permitted positions defined by a pre-determined geofence and the MTSD reports a security event if the pre-determined geofence is violated.

26) A modular tracking security device as in claim 1 wherein the BM CPU enables storage of multiple pre-programmed and threshold events within the BM CPU.

27) A modular tracking security device as in claim 1 wherein the BM and CM local area network interfaces are wireless.

28) A modular tracking security device as in claim 1 wherein the BM and CM local area network interfaces are wired.

29) A modular tracking security device system enabling an MTSD as in claim 1 to communicate with an auxiliary MTSD wherein the MTSD includes a second local area network (LAN) modem for operative establishment of a LAN with the at least one auxiliary MTSD and wherein the auxiliary MTSD includes:
an auxiliary CPU;
an auxiliary LAN modem for communication with the second LAN modem; and,
at least one sensor operably connected to the auxiliary CPU;
wherein the auxiliary MTSD reports sensor data to the MTSD for reporting to the monitoring system.

30) A modular tracking security device system as in claim 29 wherein the MTSD and auxiliary MTSD communicate over a MESH network.

31) A modular tracking security device (MTSD) for determining the position of a shipment and reporting the position and status of the shipment to a monitoring system, comprising:
a base module, the base module including
an MTSD central processing unit (CPU);
a radio frequency (RF) positioning system connected to the MTSD CPU, the RF positioning system including a global navigation satellite system (GNSS) receiver and a cellular network transceiver for determining the position of the MTSD based on data received from either or a combination of GNSS and cellular network data;
an MTSD power supply;
at least one sensor connected to the MTSD CPU for detecting a security event with respect to the shipment;
wherein the base module is operative to respond to a position enquiry from the monitoring system over the cellular network and to report position to the monitoring system in response to a position enquiry or a security event and wherein, in the absence of a position enquiry or security event, the MTSD is in a power save mode.

32) A modular tracking security system for determining the position of a shipment and reporting the position of the shipment to a monitoring system, comprising:
a base module including a central processing unit (CPU);
a local area network modem; and,
at least one sensor for detecting a security event with respect to the shipment;
wherein the base module is operative to report security event data and to receive and respond to command data over a local area network wherein, in the absence of a command data or security event, the base module is in a power save mode;
a position module including a position module central processing unit (CPU), a global navigation satellite system (GNSS) receiver and a cellular network transceiver for determining the position of the position module based on data received from either or a combination of GNSS and cellular network data, the position module also for relaying command data from the monitoring system to the base module over the local area network and for relaying security event data from the base module to the monitoring system wherein, in the absence of a command data or security event, the base module is in a power save mode.

33) A tracking device as in claim 32 further comprising an aircraft detection system to detect the MTSD's presence within an aircraft, wherein the BM CPU switches the MTSD to an aircraft mode when the MTSD is within the aircraft prior to take-off and the RF positioning system is turned off, and wherein the aircraft detection system detects that the MTSD has landed and the MTSD CPU switches the RF positioning system to the power save mode.

34) A method for automatically turning a radio frequency device having a radio frequency communication system on or off when the radio frequency device is inside or outside an aircraft comprising the steps of:
I-whilst an aircraft is on the ground,
(a) monitoring any one of or a combination of pressure data, spectral data, accelerometer data and noise data for threshold values;
(b) interpreting the data from step a) to determine if the radio frequency device is within an aircraft; and,
(c) turning off the radio frequency communication system if step (b) determines the radio frequency device be within an aircraft;
II-whilst the radio frequency communication system is turned off,
(d) monitoring any one of or a combination of pressure data, spectral data, accelerometer data and noise data for threshold values;
(e) interpreting the data from step (d) to determine if the radio frequency device is within an aircraft; and,
(f) turning on the radio frequency communication system if step (e) determines the radio frequency device be outside an aircraft;

35) A tracking and security system (TSS) comprising:
a modular tracking security device (MTSD) for determining the position of a shipment and reporting the position and status of the shipment to a monitoring system, the MTSD including:
a base module, the base module including a central processing unit (CPU),
a radio frequency (RF) positioning system including a global navigation satellite system (GNSS) receiver and a cellular network transceiver for determining the position of the MTSD based on data received from either or a combination of GNSS and cellular network data;
at least one sensor for detecting a security event with respect to the shipment and wherein the base module is operative to respond to a position enquiry from the monitoring system over the cellular network and to report position to the monitoring system in response to a position enquiry or a security event wherein, in the absence of a position enquiry or security event, the MTSD is in a power save mode.
wherein the monitoring system can request and receive position data from the MTSD and receive security event data from the MTSD.

36) A tracking and security system (TSS) as in claim 35 wherein the monitoring system can dynamically and remotely change sensor parameters of the at least one sensor.
